(19) United States
(12) Patent Application Publication
(10) Pub. No.: US 2018/0236977 A1
(43) Pub. Date: Aug. 23, 2018

(54) DRIVE DEVICE FOR A WINDSCREEN WIPING DEVICE

(71) Applicant: Robert Bosch GmbH, Stuttgart (DE)

(72) Inventors: Alexander Dudek, Offenburg (DE); Eugen Lind, Renchen-Erlach (DE); Juergen Klein, Ettlingen (DE); Michael Weiler, Buehl (DE); Ulrich Metz, Achern (DE)

(21) Appl. No.: 15/753,575

(22) PCT Filed: Aug. 1, 2016
(86) PCT No.: PCT/EP2016/068309

§ 371 Date: Feb. 20, 2018

(30) Foreign Application Priority Data
Aug. 20, 2015 (DE) 10 2015 215 956.6

(51) Int. Cl. B60S 1/24; B60S 1/34

(52) U.S. Cl. CPC B60S 1/245; B60S 1/3459; B60S 1/3443

(57) ABSTRACT

The invention relates to a drive device for a windscreen wiping device (1), comprising an electric drive motor (3) and a transmission (4) for driving an output shaft (5), said output shaft supporting the first wiper arm (6) and drives a transmission rod assembly (8) which actuates a second wiper arm (13). The invention relates to, in particular, the connection of the drive shaft to the transmission rod assembly.

### BACKGROUND OF THE INVENTION

The invention relates to a drive device for a windscreen wiping device.

In the German patent application DE 102 61 926 A1, a drive device for a windscreen wiping device in a motor vehicle is described, which comprises a drive unit having an electric drive motor and a downstream transmission, in which the rotational movement of the drive motor is converted into an oscillatory movement of an output shaft. The output shaft supports a first wiper arm, which rests on the vehicle window pane to be cleaned. In addition, the output shaft drives the transmission rod assembly, by means of which a further shaft is set into a turning oscillating movement, said further shaft supporting a second wiper arm that lies on the vehicle window pane. This embodiment has the advantage that only one drive unit comprising an electric drive motor for the drive of two wiper arms is required.

### SUMMARY OF THE INVENTION

The aim underlying the invention is to configure a drive device for a windscreen wiping device, which comprises an electric drive motor and a transmission, a first wiper arm as well as a transmission rod assembly comprising a second wiper arm, in such a way that both wiper arms can be reliably actuated over a long operating time period.

The drive device according to the invention is used for a windscreen wiping device in a vehicle, for example for a windscreen wiper for cleaning the windscreen and comprises a drive unit comprising an electric drive motor and a downstream transmission, via which the rotational movement of the drive motor is converted into an oscillatory movement of an output shaft. The output shaft supports a first wiper arm, the wiper blade of which rests on the vehicle window pane to be cleaned. In addition, a component of a transmission rod assembly engages on the output shaft, by means of which a further shaft is set into an oscillatory movement, wherein the further shaft supports a second wiper arm comprising a wiper blade that rests on the vehicle window pane. The output shaft, which is driven directly via the transmission from the drive motor, consequently drives the second shaft comprising the second wiper arm via the transmission rod assembly.

The first wiper arm is coupled to the output shaft in a rotationally fixed manner via a first connection point. A component of the transmission rod assembly engages at a second connection point that is spaced apart axially and is likewise coupled to the output shaft in a rotationally fixed manner. This component, for example a crank, therefore carries out the same oscillatory movement as the output shaft, which by means of further components of the transmission rod assembly is converted into the desired oscillatory movement of the second shaft that supports the second wiper arm. The second wiper arm can, in this case, carry out either a rectified wiping movement as the first wiper arm or a wiping movement directed oppositely.

The first and the second connection point on the output shaft are basically similarly constructed and in each case ensure a rotationally fixed coupling of the first wiper arm or respectively of the component of the transmission rod assembly comprising the output shaft. This coupling is ensured by means of a connecting portion per connection point on the output shaft. A hub of the first wiper arm or respectively of the component of the transmission rod assembly is mounted in a force-fitting or positive-locking manner on said connecting portion. During assembly, the component of the transmission rod assembly comprising a hub-shaped recess is, for example, first fitted to the output shaft axially until reaching the associated connecting portion. The wiper arm comprising a hub-shaped recess is subsequently placed on the associated connecting portion on the output shaft.

When fitting the component of the transmission rod assembly or respectively the wiper arm to the respectively associated connecting portion, the force-fitting or positive-locking connection takes place, which, for example, is thereby achieved in that the connecting portion in question on the output shaft has a roughened or irregular surface. The hub of the component of the transmission rod assembly or respectively wiper arm can be axially pushed onto the connecting portion in the form of a press fit, whereby the desired rotationally fixed coupling is achieved in the circumferential or respectively rotational direction. This can take place either by means of a force-fitting and/or a positive-locking connection between the connection partners.

The connection points on the output shaft are preferably constructed in the same manner, whereby a uniformity and standardization of the connections is achieved. It can, for example, be expedient to configure the connection sections on the output shaft in each case as a knurled section with a fluted surface. The knurled section has, for example, a fluting parallel to the longitudinal axis of the output shaft, which supports the rotationally fixed coupling to the first wiper arm or respectively to the component of the transmission rod assembly. There are, however, other fluting patterns as an option, for example a crosswise fluting. The hub-shaped recess in the wiper arm or respectively in the component of the transmission rod assembly can likewise be provided with a fluting or knurling in order to support the production of a rotationally fixed coupling.

In the case of a force-fitting connection in the region of the two connection points, the surfaces on the lateral surface of the output shaft are advantageously designed in a rotationally symmetrical manner in the region of the connecting portion as well as on the inside of the hub-shaped recess on the wiper arm or respectively on the component of the transmission rod assembly. A positive-locking connection can, however, also be taken into consideration, in the case of which the respective surfaces are embodied in a non-rotationally symmetrical manner, for example as a polygon. In addition, a combination of a form-fitting and positive-locking connection is possible by the surfaces being embodied in a non-rotationally symmetrical manner and at the same time having a roughened surface in the form of a fluting or knurling.

The connecting portions can, for example, be designed conically or cylindrically. In so doing, it is possible that both connecting portions on the output shaft are conically as well as both connecting portions are cylindrically designed. An embodiment having a conical connecting portion and a cylindrical connecting portion can furthermore come into consideration, for example a conical embodiment for the coupling between the output shaft and the first wiper arm adjacent to the end face of the output shaft and a cylindrical embodiment for the coupling between the output shaft and the component of the transmission rod assembly.

According to a further advantageous embodiment, the output shaft has on both of the sections thereof, which delimit the connecting portion axially from the transmission rod assembly, a different diameter. These output shaft sections are in each case designed cylindrically. The component of the transmission rod assembly, which, by means of the hub-shaped recess thereof, is pushed onto the output shaft until reaching the associated connecting portion, is preferably placed over the output shaft section having the smaller diameter, wherein the opposing output shaft section having the larger diameter forms a stop for delimiting how far said component of the transmission rod assembly can be axially pushed onto said output shaft.

It can furthermore be advantageous to install threads for receiving a nut on the output shaft adjacent to the connecting portion to the transmission rod assembly. The screwed on nut secures the component of the transmission rod assembly in the axial position thereof on the output shaft. Securing said component is, for example, however also possible by producing an axial stop on the output shaft, which, for example, is produced by reshaping by means of wobble riveting. A diameter reduction in the encompassing component of the transmission rod assembly by means of ring caulking can additionally be considered in order to achieve an improved rotational locking as well as an axial locking of the component on the output shaft.

### BRIEF DESCRIPTION OF THE DRAWINGS

Further advantages and expedient embodiments can be extracted from the additional claims, the description of the figures and the drawings. In the drawings:

FIG. 1 shows a windscreen wiping device in a schematic depiction for a vehicle, comprising a drive device, which comprises a drive unit with an electric drive motor and a transmission via which an output shaft is driven, on which output shaft a first wiper arm rests, comprising as well a transmission rod assembly for driving a second wiper arm;

FIG. 2 shows the drive device comprising the output shaft, which has a first conical connecting portion in the region of the free end face thereof and a second conical connecting portion that is axially spaced apart from said first connecting portion;

FIG. 3 shows a depiction of the drive device corresponding to FIG. 2, wherein the second connecting portion is cylindrically configured;

FIG. 4 shows the drive device in a further embodiment variant, in which a circumferential shoulder that forms a stop is produced by wobble rivets on the lateral surface of the output shaft;

FIG. 5 shows a drive device in a further embodiment variant, in which the transmission part fitted to the second connecting portion is connected axially and in the circumferential direction to the output shaft by means of ring caulking;

FIG. 6 shows an output shaft with knurling and recesses.

In the figures, identical components are provided with identical reference signs.

### DETAILED DESCRIPTION

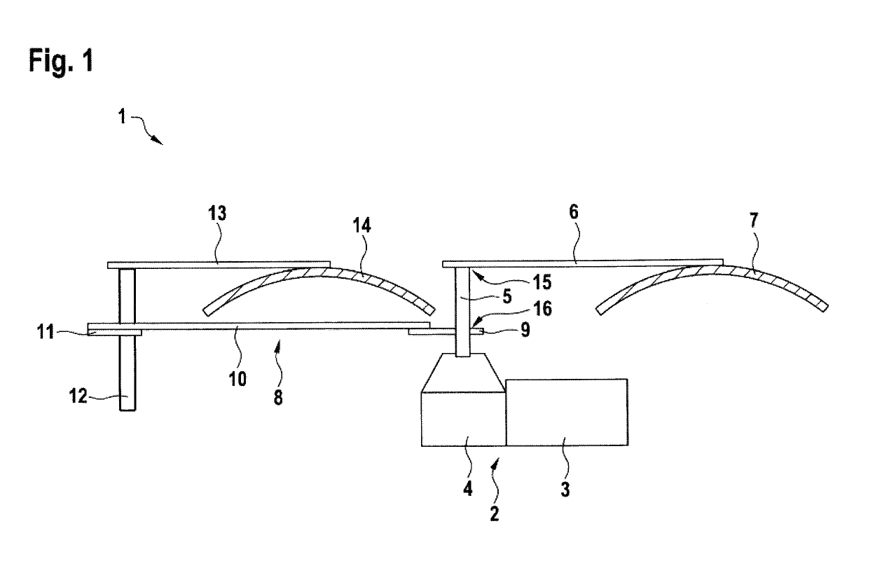

In FIG. 1, a windscreen wiping device 1 for a motor vehicle is depicted, with which, for example, the windscreen of the vehicle can be cleaned. The windscreen wiping device 1 comprises a drive device 2 with a drive unit, which consists of an electric drive motor 3 and a downstream transmission 4, in which the rotatory drive movement of the drive motor 3 is converted into a turning oscillating movement of an output shaft 5 that is driven directly by the transmission 4. A first wiper arm rests in the region of the free end face, said wiper arm supporting one of the wiper blades 7 resting on the vehicle's windscreen.

Spaced apart axially from the connection point 15 between the output shaft 5 and the first wiper arm 6, a second connection point 16 is disposed on the output shaft. A transmission rod assembly 8 is driven via said second connection point, said transmission rod assembly being coupled to a further shaft 12 that supports a second wiper arm 13 comprising a wiper blade 14, which likewise rests on the vehicle's windscreen. The transmission rod assembly 8 comprises a crank 9, a crank rocker mechanism 10 as well as a lever 11, of which the crank 9 is connected in a rotationally fixed manner to the output shaft 5 and the lever 11 is connected in a rotationally fixed manner to the further shaft 12, on which the second wiper arm 13 is mounted. The intermediate crank rocker mechanism 10 is coupled in an articulated manner to the crank 9 as well as to the lever 11.

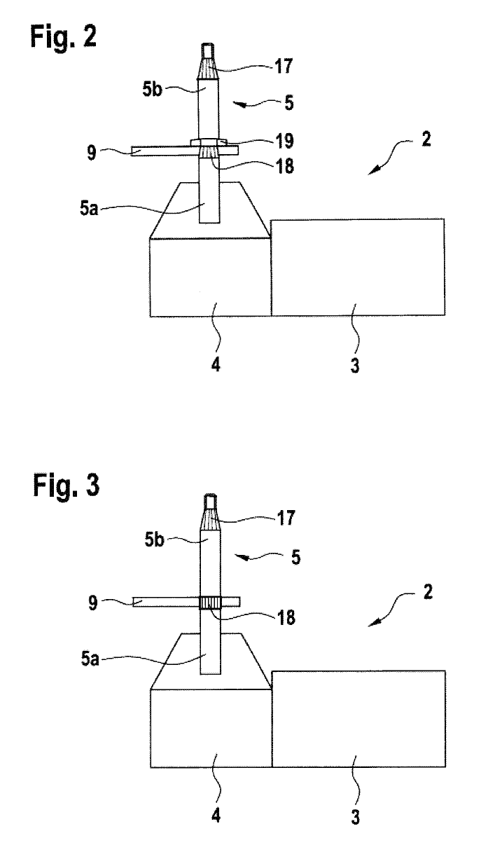

In FIGS. 2 to 5, connecting portions 17 and 18 on the output shaft 5, which are component parts of the connection points to the wiper arm or respectively to the transmission rod assembly comprising the crank 9, are depicted in each case in detail in different embodiment variants. According to FIG. 2, both connecting portions 17 and 18 are adjacent to the free end face or respectively are designed conically and to be spaced apart from the end face and provided with a fluting or knurling, which has a plurality of fluted notches that run axially. A hub-shaped recess of the first wiper arm 6 or respectively the crank 9 is placed in each case onto the conical connecting portions 17 and 18, wherein the wiper arm and the crank are connected in a rotationally fixed manner to the output shaft 5. This relates thus in principle to a similar connection between the output shaft in the region of the connecting portions 17, 18 to the first wiper arm or respectively to the component of the transmission rod assembly.

The further exemplary embodiments according to the FIGS. 3 to 5 have similar connecting portions 17 and 18 for connecting to the first wiper arm or respectively to the transmission rod assembly. The connecting portion 17, 18 is in each case provided with a fluting or knurling in order to ensure an improved rotationally fixed connection to the wiper arm or to respectively the component of the transmission rod assembly.

As furthermore can be seen in FIG. 2, a nut 19 is mounted on the output shaft 5, said nut being screwed onto an external thread which is introduced into the lateral surface of the output shaft 5 directly axially adjacent to the second connecting portion 18. The two output shaft sections 5a and 5b, which adjoin the second conical connecting portions 18 on different sides, have differently large diameters, wherein the output shaft section 5b that is adjacent to the free end face has a smaller diameter than the output shaft section 5a. The conical second connecting portion 18 thus has a larger diameter on the side facing the output shaft section 5a than on the side facing the output shaft section 5b.

Furthermore, in the further exemplary embodiments according to the FIGS. 3 to 5, the output shaft 5 has two cylindrical output shaft sections 5a, 5b having diameters that vary in size, of which the output shaft section 5a has the larger diameter on the side facing away from the free end face. According to FIG. 3, the first connecting portion 17 on the end face side is conical and the second connecting portion 18, which is spaced apart axially thereto, is designed cylindrically. Due to the larger diameter of the output shaft portion 5a, the transition between the connecting portion 18 and the output shaft section 5a forms a radially enlarged ring shoulder, which forms a stop for the crank 9. The crank 9 can thus be axially pushed over the free end face of the output shaft 5 up until reaching the second connecting portion 18 and the ring shoulder at the transition of the second connecting portion 18 to the output shaft section 5a.

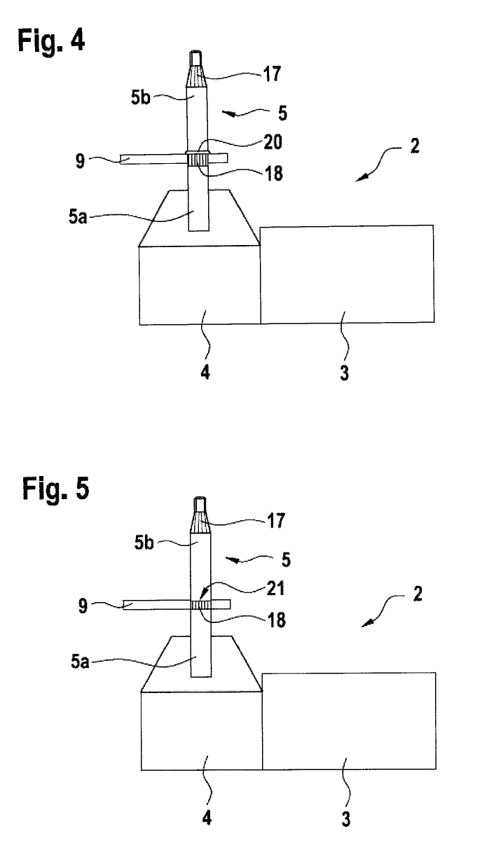

In the FIGS. 4 and 5, the output shaft 5 also has a conical first connecting portion 17 and a cylindrical second connecting portion 18. According to FIG. 4, the output shaft 5 is deformed on the upper side of the second connecting portion 18 in the region of the lateral surface thereof, whereby a radially slightly extended stop 20 results, which secures the crank 9 axially in the position thereof. The deformation is produced, for example, by means of wobble riveting. The crank 9 is thus held axially downwards by means of the larger diameter of the output shaft section 5a and axially upwards by means of the deformed stop 20.

In FIG. 5, the crank 9 is deformed in the region of the hub-shaped recess by means of the ring caulking on the upper axial edge as is denoted by the reference sign 21, whereby the crank 9 is axially secured in the upwards direction. If need be, the edge of the crank 9 that lies axially downwards can also be ring caulked.

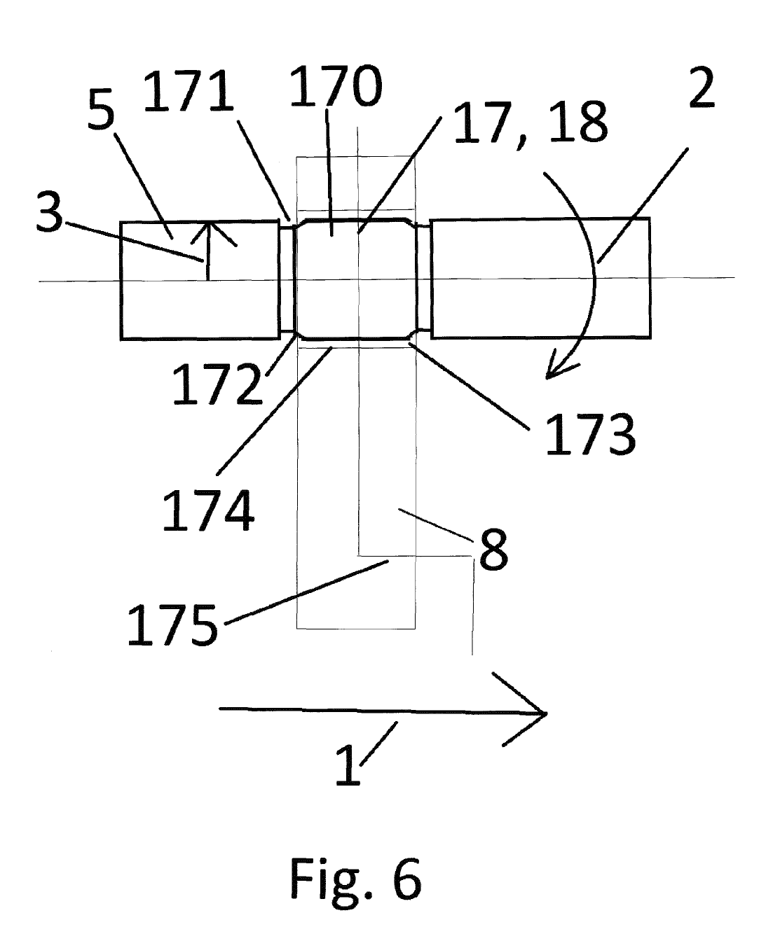

In FIG. 6, the drive device is shown. The drive device is for a windscreen wiping device 1, having a drive unit comprising an electric drive motor 3 and a transmission 4, said drive unit having an output shaft 5, which supports a first wiper arm 6. The drive device 1 further comprises a transmission rod assembly 8 for driving a second wiper arm 13, wherein a first and a second connection point 15, 16 to the first wiper arm 6 or respectively to the transmission rod assembly are disposed on the output shaft 5 so as to be axially spaced apart from one another, characterized in that the connection points 15, 16 are configured as shaft-hub connections, wherein a connecting portion 17,18 is disposed in each case on the output shaft 5 in the region of the connection points 15, 16. A hub of the first wiper arm 6 or respectively of the component of the transmission rod assembly is mounted in a force-fitting or positive-locking manner on said connecting portion 17, 18, wherein the connecting portion 18 is knurled, and the connecting portion 18 is pressed into a smooth-walled bore (173) of the transmission rod assembly 8, so that the smooth wall of the bore 173 is deformed in accordance with the knurling 170. The transmission rod assembly 8 has as bore 173, which depicts a through-bore. This bore 173 has a cylindrical wall which is substantially smooth. In this way, a particularly solid connection is achieved between transmission rod assembly and output shaft because the material of the transmission rod assembly is squished by the press fit process and flows into the knurling 170. As a result, a force-fitting as well as positive-locking connection is achieved.

The drive device is knurled on the connecting portions 17, 18. In so doing, a recess 171 is disposed in the axial direction 1 in front of/or behind the connecting portions 17, 18.

A chamfer 172 with respect to the axial direction is formed by means of the recess 171 at the end portion of the knurling 170, said chamfer extending in the circumferential direction 2. The recess 171 has the effect that the edge of the knurling 170 is flattened in relation to the radial direction 3. As a result, a type of chamfer arises on the axial edge of the knurling 170; thus enabling the press fit to better take place into the bore 173.

In the process, the transmission rod assembly 8 can be offset. The offset 172 occurs in the axial direction 1 so that the bore 174 and a part of the transmission rod assembly 8 are disposed in different planes in relation to axial direction 1.

It is also conceivable that the bore 174 has a multi-sided profile. It is possible that this relates to a three-sided, four-sided, five-sided, six-sided, seven-sided, eight-sided or polygonal profile. In so doing, the connecting portion 17, 18 has a complementary multi-sided profile of the same order. It is thereby conceivable that the connecting portion 17, 18 has a knurling 170. It is also conceivable that the connecting portion 17, 18 does not have a knurling 170.

It is possible to arrange the transmission rod assembly 8 on the connecting portion 17, 18, and to weld said assembly on said connecting portion by means of a laser welding step. In so doing, the weld can take place on the top side as well as the bottom side in relation to the axial direction 1.

It is also conceivable for the transmission rod assembly 8 to be fastened to the output shaft 5 by means of a speed nut. A speed nut has to only be pushed onto the output shaft 5, so that the transmission rod assembly 8 is fixed in the axial direction 1. The speed nut is preferably made from sheet metal in this case.

The transmission rod assembly 8 is pushed onto the knurling in one step of the method. In so doing, the rod assembly 8 is pushed on to the extent that it covers the knurling 170. As a result, a press fit between knurling 170 and bore 173 is produced, which leads to the material of the bore 173 being deformed. The wall 174 is deformed to the extent that said wall penetrates into the profile of the knurling 170. The rod assembly 8 does not have to abut against an axial stop, but can be pushed on as far as is necessary that the axial mounting dimension of the rod assembly 8 is achieved. This dimension can, e.g., conform to the knurling 170; thus enabling the maximum strength of the connection between knurling 170 and rod assembly 8 to be achieved by the press fit and deformation when a maximum covering of the knurling 170 occurs.

1. A drive device for a windscreen wiping device (1), comprising an electric drive motor (3) and a drive unit comprising a transmission (4) and an output shaft (5), said output shaft supporting a first wiper arm (6), and comprising a transmission rod assembly (8) for driving a second wiper arm (13), wherein a first and a second connection point (15, 16) to the first wiper arm (6) and the transmission rod assembly (8), respectively, are disposed on the output shaft (5) so as to be axially spaced apart from one another, characterized in that the first and second connection points (15, 16) are shaft-hub connections, wherein first and second connecting portions (17, 18) are disposed on the output shaft (5) in regions of the first and second connection points (15, 16), respectively, on which first and second connecting portions hubs of the first wiper arm (6) and a component of the transmission rod assembly (8) are respectively mounted in a force-fitting or positive-locking manner, wherein the second connecting portion (18) is knurled, and the second connecting portion (18) is pressed into a smooth-walled bore (173) of the component of the transmission rod assembly (8) so that a smooth wall (174) of the bore (173) is deformed in accordance with the knurling (170).

2. The drive device according to claim 1, wherein the first and second connecting portions (17,18) are knurled, and wherein a recess (171) is disposed in front of and/or behind each of the connecting portions (17,18).

3. The drive device according to claim 1, characterized in that end portions of the knurlings (170) have a chamfer (172) in relation to an axial direction (1) of the output shaft, which chamfer extends in a circumferential direction (2).

4. The drive device according to claim 1, characterized in that the transmission rod assembly (8) is offset.

5. The drive device according to claim 1, characterized in that the output shaft (5) has substantially the same diameter immediately after the recess as the knurling (170) so that a stop is not formed for the transmission rod assembly.

6. The drive device according to claim 1, characterized in that the transmission rod assembly (8) on the output shaft (5) does not have an axial contact surface with the output shaft (5).

7. The drive device according to claim 1, characterized in that the bore (173) has a multi-sided profile.

8. The drive device according to claim 1, characterized in that the transmission rod assembly (8) is fastened to the output shaft (5) by laser welding.

9. The drive device according to claim 1, characterized in that the transmission rod assembly (8) is fastened to the output shaft (5) by a speed nut.

10. A method for manufacturing the drive device according to claim 1, the method comprising pushing the transmission rod assembly (8) onto the second connecting portion (18) to an extent that said second connecting portion has a maximum coverage with the wall (174), wherein the transmission rod assembly (8) does not abut against an axial stop.
